(19) United States
(12) Patent Application Publication
(10) Pub. No.: US 2026/0310508 A1
(43) Pub. Date: Oct. 8, 2026

(54) SEAMLESS TRANSITION BETWEEN ON-DEVICE, MOBILE, AND CLOUD-BASED AI/ML MODELS

(71) Applicant: Panasonic Well LLC, Palo Alto, CA (US)

(72) Inventor: Ramin Firoozye, San Francisco, CA (US)

(21) Appl. No.: 19/276,876

(22) Filed: Jul. 22, 2025

Related U.S. Application Data
(60) Provisional application No. 63/783,829, filed on Apr. 4, 2025.

(51) Int. Cl. G06F 9/50

(52) U.S. Cl. CPC G06F 9/5027

(57) ABSTRACT

Techniques for determining machine-learning model deployments based on device and network characteristics associated with requests are provided. A computer-implemented method can include accessing a request to perform one or more operations using a machine-learning model, in which the request is associated with a user. The computer-implemented method can also include identifying an intent associated with the request. The computer-implemented method can also include determining a processing route for processing the request. In some instances, the processing route is determined based on the request and the intent. The processing route can include: (i) an event that identifies actions to fulfill the request; (ii) a target that identifies resource endpoints to which the event is being directed; and (iii) a payload that includes metadata of the request. The computer-implemented method can also include identifying computing resources for processing the request, in which the computing resources are identified based on the processing route.

### CROSS-REFERENCES TO RELATED APPLICATIONS

The present patent application claims the priority benefit of U.S. Provisional Patent Application 63/783,829 filed Apr. 4, 2025 and is related to U.S. Patent Applications entitled “ABILITY-BASED USER INPUT INTERFACE” (POL Ref. 109304-845007-008900US) filed Jul. 22, 2025 and “MULTI-MODAL INTERACTION FOR PEOPLE WITH DISABILITY” (POL Ref. 109304-845017-009000US) filed Jul. 22, 2025, U.S. Provisional Application 63/783,813 filed Apr. 4, 2025 entitled “ABILITY-BASED USER INPUT INTERFACE” and U.S. Provisional Application 63/783,817 filed Apr. 4, 2025 entitled “MULTI-MODAL INTERACTION FOR PEOPLE WITH DISABILITY”, the disclosures of which are incorporated herein by reference in its entirety for all purposes.

### FIELD

The present disclosure relates generally to determining machine-learning model deployments based on device and network characteristics associated with requests. In one example, the systems and methods described herein may be used for selecting and transitioning machine-learning deployments based on device and network characteristics.

### SUMMARY

Disclosed embodiments may provide techniques for determining machine-learning model deployments based on device and network characteristics associated with requests. A computer-implemented method can include accessing a request to perform one or more operations using a machine-learning model, in which the request is associated with a user. The computer-implemented method can also include identifying an intent associated with the request. In some instances, the intent identifies one or more intended inputs for the machine-learning model and an expected output to be generated by the machine-learning model in response to the one or more intended inputs. The computer-implemented method can also include determining a set of attributes to the request. In some instances, the set of attributes are determined based on the intent, and the set of attributes identify one or more device or network characteristics associated with processing the intent.

The computer-implemented method can also include determining a processing route for processing the request. In some instances, the processing route is determined based on the request, the intent, and the set of attributes. The processing route can include: (i) an event that identifies one or more actions to fulfill the request; (ii) a target that identifies resource endpoints to which the event is being directed; and (iii) a payload that includes metadata associated with the request. The computer-implemented method can also include identifying computing resources for processing the request, in which the computing resources are identified based on the processing route. The computer-implemented method can also include deploying the machine-learning model to the computing resources. The computer-implemented method can also include processing the request using the deployed machine-learning model to perform the one or more operations.

In an embodiment, a system comprises one or more processors and memory including instructions that, as a result of being executed by the one or more processors, cause the system to perform the processes described herein. In another embodiment, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Illustrative embodiments are described in detail below with reference to the following figures.

FIG. 1 illustrates a schematic diagram of an example user interaction with machine-learning systems.

FIG. 2 illustrates an example schematic diagram for processing requests with multi-modal input and various network characteristics, according to some embodiments.

FIG. 3 illustrates an example schematic diagram for selecting and transitioning machine-learning deployments based on device and network characteristics, according to some embodiments.

FIG. 4 illustrates a schematic diagram for implementing a context processor for transitioning of machine-learning models, according to some embodiments.

FIG. 5 illustrates a schematic diagram for determining accessible resources and deployment options for processing machine-learning requests, according to some embodiments.

FIG. 6 shows an illustrative example of a process for selecting and transitioning machine-learning deployments based on device and network characteristics, in accordance with some embodiments.

FIG. 7 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### I. Techniques for Transition Between On-Device, Mobile, and Cloud-Based AI/ML Models

### A. Overview

### 1. Technical Problem

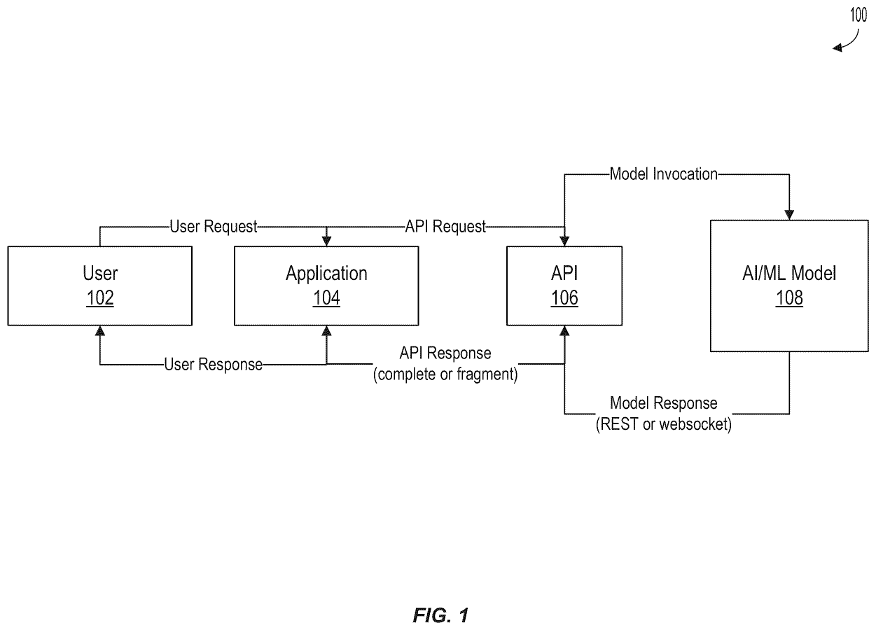

Interaction with Artificial Intelligence/Machine-Learning (AI/ML) systems typically involves deploying a trained model and querying it via application programming interfaces (APIs). The response is then returned by the AI server, which can then be formatted and presented on a graphical user interface of the application. FIG. 1 illustrates a schematic diagram 100 of an example user interaction with machine-learning systems. As shown in FIG. 1, the workflow begins with a user 102 initiating a request through an application 104 with a user interface. The request is routed by the application 104 via an API endpoint 106 or Software Developer Kit (SDK). The API 106 can invoke the selected model file that identifies a respective machine-learning model 108, at which the machine-learning model 108 can perform the necessary computations to evaluate the request and return a response. In some instances, the above process occurs in a single run, providing an immediate response. However, when a particular request requires time-consuming computations, the model may deliver results in fragments directly to the user in parts. As an alternative, the results can also be sent to an intermediate system that assembles the fragments and performs post-request processing.

While such existing machine-learning systems are configured to facilitate efficient interaction, there are instances where the response may be incorrect or the request may not be fulfilled. Several factors contribute to these limitations. An example of the limitations can include insufficient processing power, storage, or memory. In some instances, model “hallucination” can occur, in which the model generates false or misleading outputs. Other examples of the limitations can include limitations in the training data, the model being unsuitable for the specific request, and restricted access to necessary external data. Additionally, resources required for processing may be unavailable at the time of the request, and privacy concerns or local regulations may impose further restrictions. Under these circumstances, the request may be denied or result in a timeout.

### 2. Example Implementation

To address these challenges, the present techniques provide a model-transition system that enables seamless transitions between a range of machine-learning models, while optimizing request handling based on available computing resources. By dynamically selecting the most suitable machine-learning model for a given request and surrounding context (e.g., number of available computing resources), the present techniques ensure more reliable and efficient AI/ML interactions while mitigating common system limitations.

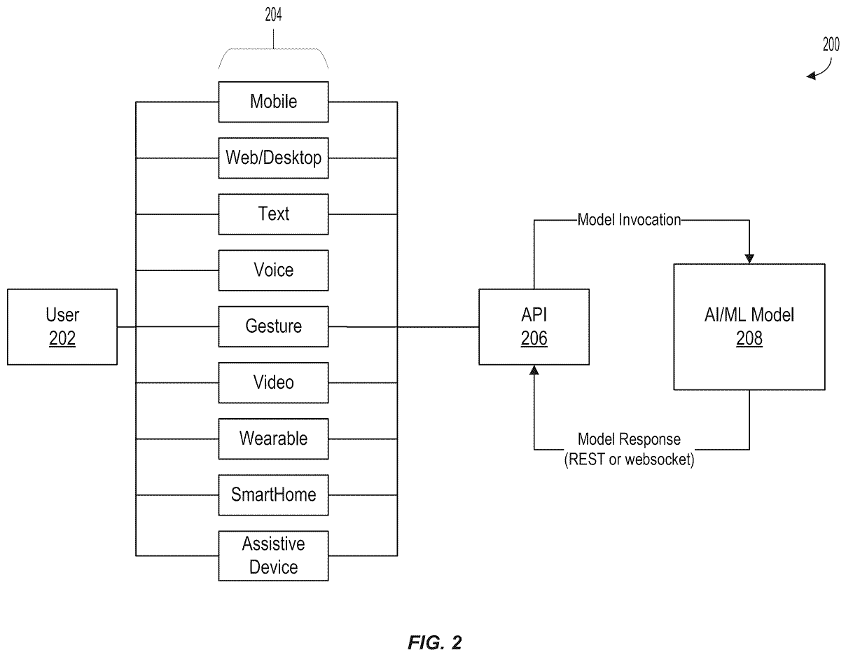

FIG. 2 illustrates an example schematic diagram 200 for processing requests with multi-modal input and various network characteristics, according to some embodiments. When a user 202 generates a request through a user interface, the request can be associated with various device and network characteristics 204, including the available input methods and the nature of the interaction. For example, the request can indicate that a combination of the following types of input were used: (i) text input in which users type text commands or queries; (ii) user-interface controls such as buttons, sliders, or toggles that allow for structured interactions; (iii) voice input including live audio streams or previously recorded sessions; (iv) vision-based inputs that enable interactions through live camera feeds or previously captured photos and videos; and (v) gesture-based inputs that interpret hand movements or other body gestures to trigger actions. The device and network characteristics 204 can also indicate that the request was transmitted via local communication via wired or wireless interfaces such as Bluetooth Low Energy (BLE), Zigbee, ZWave, NFC, Thread, Matter, CANBus, or Ethernet, or the request was inputted using inputs from accessory devices like physical buttons, lights, screens, keyboards, or accessibility devices designed for users with special needs. Finally, the device and network characteristics 204 can indicate that the request includes data from device sensors, including motion detectors, NFC scanners, GPS modules, Bluetooth signals, and environmental sensors, or the request was generated from environmental devices such as SmartHome systems or ambient controls that adjust settings based on real-world conditions.

Once a request is made, the request is routed to an application (via an API 206) capable of processing and handling such requests, at which the request can be processed by a corresponding machine-learning model 208. The application can be hosted on various platforms, including mobile applications running on smartphones or tablets, wearable devices like smartwatches or fitness trackers, networking gateways or routers that manage local communications, and standalone devices designed for specific tasks. Additionally, interactions may be handled through television sets, voice-activated assistants such as Amazon Alexa or Google Home, or applications and plugins integrated into other software environments.

The operation in response to the request can be performed by the devices at different network locations, depending on the device's capabilities and the nature of the request. Some operations are executed locally on the device itself, leveraging on-device processing to reduce latency and improve security/privacy. In other cases, a peer node (e.g., a nearby compute device) may handle the request, while more complex computations might be offloaded to a gateway or server. The requests may also be routed to an “assistant” device that specializes in handling such queries, to a distributed or centrally shared server within an organization, or a cloud-based service that provides scalable computing resources to process the request.

In some instances, the physical location of these devices varies and may influence how the request is processed. Devices may be located in the same or another room as the user, within an office or apartment complex. In other situations, devices can be located in larger shared environments such as schools, hospitals, sports stadiums, museums, and commercial locations. In some cases, requests may be processed within moving environments including in-transit vehicles such cars, buses, trains, boats, or airplanes, in which connectivity and computing resources can fluctuate based on network availability.

The present techniques can identify a particular type of machine-learning model and a method of its deployment based on the above characteristics of the request. For example, when a request is received, the model-transition system evaluates whether the request can be handled locally, should be processed via a shared resource, requires cloud computing, or cannot be completed at all. The deployment decision can include assessing multiple factors, including the computational cost of executing the request, external constraints such as network bandwidth and latency, user account permissions, and commercial considerations like cost allocations per request. Other types of the deployment assessment can also include available computing resources (e.g., CPU, RAM, GPU, NPU, TPU, etc), volume of traffic, or tariffs associated with use of the machine learning model. The assessment could also be determined statically or dynamically at runtime. Another example attribute can include regional proximity, as well as local regulatory requirements related to data sovereignty or privacy.

By dynamically selecting the most efficient processing and deployment method based on these variables, the model-transition system ensures a balance between performance, cost, and resource availability while maintaining an optimal user experience.

### B. Computing Environment

As previously described, the model-transition system enables a wide range of multi-modal user interactions, allowing requests to be made through text, voice, gesture, and other input methods. Then, the model-transition system intelligently matches each request to the most suitable available resources, which may be located on the user's device, within the local environment, or at a remote processing center. By dynamically selecting the optimal mechanism for handling each request, the system ensures efficient and seamless operation across various platforms and computing environments.

Moreover, the model-transition system can also support real-time dynamic re-routing of the requests between different environments, which enhances its resilience and adaptability. For example, if a device or network fails or becomes unavailable mid-request (e.g., the device enters an area at which network availability can be unpredictable), the model-transition system can gracefully redirect the request to an alternative resource without disrupting the user experience. In addition, if a better resource becomes available in between the requests (e.g., availability of cloud service), the model-transition system can automatically transition to using the newly provisioned resource to ensure optimal performance at all times.

In the event of a failure at any point in the model-transition system, several failover mechanisms are established to minimize request disruption. For example, the model-transition system can backtrack and find alternative routes to complete the request, minimizing disruption. If no alternative path is available, the user can be promptly notified of the issue, allowing them to take appropriate action. The model-transition system also has the capability to automatically notify third parties, such as support teams or service providers, about the nature of the failure along with suggested solution. The advanced notification system enables faster resolution while maintaining service continuity. This robust approach ensures reliability and adaptability, even in dynamic and unpredictable computing environments.

### 1. Intent Processing

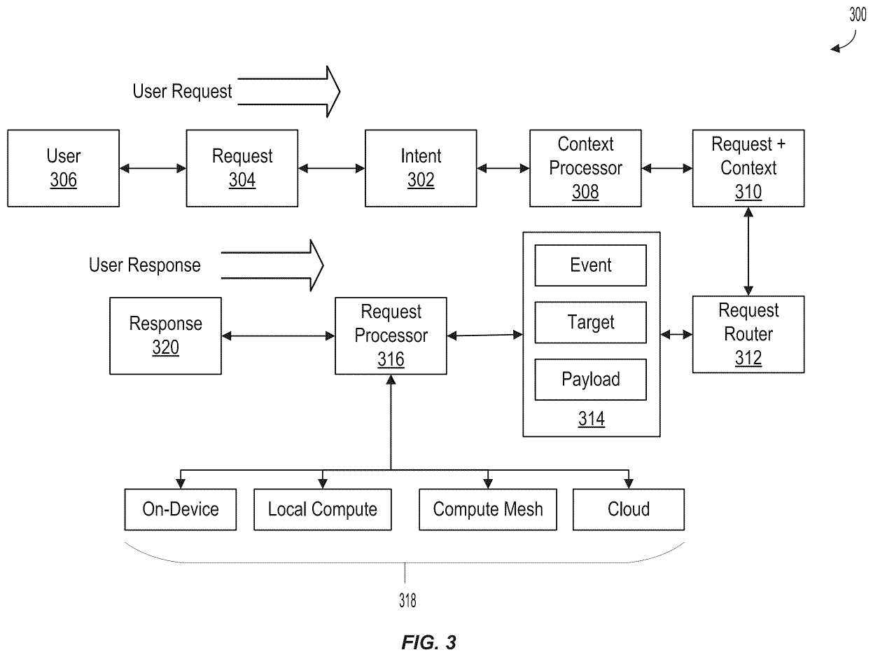

FIG. 3 illustrates an example schematic diagram 300 for selecting and transitioning machine-learning deployments based on device and network characteristics, according to some embodiments. As shown in FIG. 3, a model-transition system determines an intent 302 from a request 304 associated with a user 306. The intent 302 can identify various characteristics associated with the request 304, including one or more intended inputs to be processed by a corresponding machine-learning model as well as expected outputs triggered in response to the intended inputs. In some instances, the extracted intent includes a list of attributes. Attributes can include parameters or properties associated with the request 304, including user-provided data, measured ability levels (e.g., vision or hearing impairment), contextual metadata, or system-defined variables that refine the intent's meaning and execution. In addition, a verb/command can represent an action or directive associated with the intent, specifying a type of operation the application should perform. The type of operation can include “send,” “select,” “navigate,” or “confirm.”

The model-transition system can determine the intent by identifying the type of interaction associated with the user 306—whether it originates from text, voice, gestures, or other input methods—and then parsing the request 304 while considering the local context. To refine intent detection, the system attaches relevant metadata, such as the user's identity, location, the time of day, the user ability data as determined through a user-interaction system such as AbleUI, a mode of interaction and any other metrics that can assist in distinguishing the actual intent from surrounding interference or ambiguous inputs. Various techniques and embodiments associated with the user-interaction system are described in U.S. Patent Provisional Applications entitled “Ability-based user input interface” (POL Ref. 109304-807515) filed Apr. 4, 2025 and “Multi-modal interaction for people with disability” (POL Ref. 109304-807514) filed Apr. 4, 2025, both of which are incorporated herein by reference in its entirety and for all purposes.

In some instances, the model-transition system can extract the intent 302 by processing the request 304 using an intent-discovery machine-learning model. Examples of the intent-discovery machine-learning model (including sub-models of the multimodal model) can include algorithms such as k-means clustering algorithms, fuzzy c-means (FCM) algorithms, expectation-maximization (EM) algorithms, hierarchical clustering algorithms, and density-based spatial clustering of applications with noise (DBSCAN) algorithms, in which the algorithms can be trained using unsupervised learning. Other examples of the intent-discovery machine-learning model can include, but are not limited to, genetic algorithms, backpropagation, reinforcement learning, decision trees, linear classification, artificial neural networks, anomaly detection, and such. In yet other examples, the intent-discovery machine-learning model may include regression analysis, dimensionality reduction, metalearning, reinforcement learning, deep learning, and other such algorithms and/or methods.

In some instances, the intent-discovery machine-learning model is a transformer model (e.g., a large-language model (LLM)) obtained from a models database. In some instances, the intent-discovery machine-learning model is trained using self-supervised learning based on a large corpus of text data, such that the intent-discovery machine-learning model can generate narratives. In addition to training the model, various prompts can be used for prompt engineering of the intent-discovery machine-learning model for generating the narratives. Examples of the intent-discovery machine-learning model can include, but are not limited to, BERT model, Claude LLM, Falcon 40B, Ernie, GPT-3, GPT-3.5, GPT 4, Lamda, and Llama.

The intent 302 can thus be determined in order to unify various forms of interaction into a standardized set of tuples (e.g., a list), ensuring that requests (e.g., the request 304) are processed consistently regardless of their source or mode of entry. By structuring interactions in this manner, the system enhances its ability to interpret diverse user inputs effectively. In cases where the system cannot clearly determine the user's intent 302, the model-transition system may prompt the user 306 for clarification, refining its understanding through additional input. In some instances, the model-transition system can match the extracted intent 302 with an available list of services, ensuring that the request is aligned with its capabilities. Once the intent 302 and its associated parameters have been successfully identified, they are passed to the next stage of processing where further actions can be taken to fulfill the user's request efficiently.

### 2. Interaction Context

When determining the intent 302, a given request may either represent a new interaction or be a continuation of a previous session. Associating the intent 302 with an appropriate interaction is performed to ensure that the request is routed to the appropriate machine-learning model and deployment environments. Accordingly, a context processor 308 is configured to identify whether the request 304 is associated with a part of previous session (or entirely a new one). The context processor 308 can optimize performance, as it prevents redundant or computationally expensive routing decisions that have already been made. By recognizing continuity, the model-transition system can maintain efficiency and improve response times.

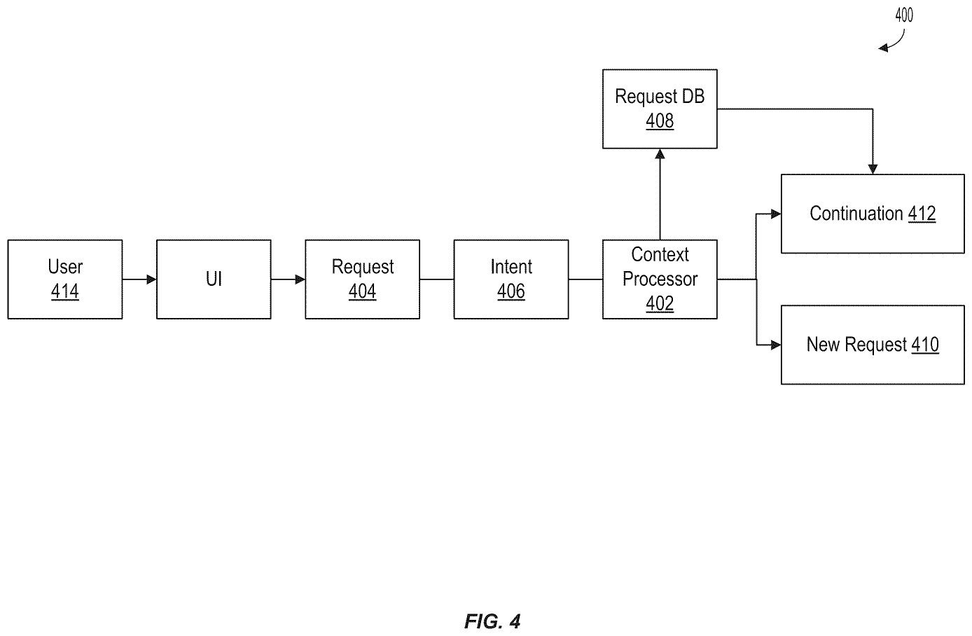

FIG. 4 illustrates a schematic diagram 400 for implementing a context processor for transitioning of machine-learning models, according to some embodiments. A context processor 402 assigns a set of attributes to a given request 404, which helps in determining how it should be handled. The set of attributes can include an intent 406 and parameters including user's identity (e.g., name, address), location, mode of interaction (e.g., voice vs. text), and user preferences. Additionally, the context processor 402 can attach operational attributes to the request 404, including network bandwidth, system load, time elapsed since the last request, and availability of computing resources like processing power and memory, proximity to alternative resources, and the cost of operation. By taking these operational attributes into account, the context processor 402 can determine the most efficient processing route for handling the request 404.

In some instances, the context processor 402 can then access a request database 408 to determine one or more existing sessions that match the set of attributes associated with the request 404. In particular, the context processor 402 can generate a query using the intent 406 and the set of attributes and submit the query to the request database 408 to retrieve query results that correspond to sessions. In some instances, the request database 408 can include relational databases that include traditional SQL-based systems such as MySQL, PostgreSQL, and Microsoft SQL Server, which use structured tables and predefined schemas to organize data efficiently. As an alternative to relational databases, embeddable database like: SQLite, RocksDB, or DuckDB and non-relational databases like MongoDB or Cassandra can be used for handling unstructured or semi-structured content elements, offering schema flexibility and high availability. In cases where flexibility in data modeling is required, hybrid databases such as NewSQL solutions offer both relational consistency and NoSQL-like scalability. Additionally, graph databases like Neo4j or Amazon Neptune can be integrated alongside relational databases to represent complex relationships between content elements, enabling more advanced queries for connected data.

If the context processor 402 classifies a request as a new request 410 (i.e., no existing intents have been found in the request database), it initiates a separate processing flow to establish a new session for the new request 410. Conversely, if the request 404 is determined to the associated with an existing session, the context processor 402 can reuse the established settings and routing paths of an existing session 412 (alternatively referred herein as “continuation”). In some instances, the context processor can compare operational attributes of the existing session 412 with those in the request 404 to determine any changing conditions, such as shifts in resource availability or the user moving to a different location. If the difference between the sets of operational attributes exceeds a threshold, the context processor 402 can adjust the deployment options and resource usage that would match the operational attributes of the request 404.

As an illustrative example, suppose a user 414 issues a voice request that is initially processed on a local gateway device. If the user follows up with another request related to the same intent 406, the context processor 402 can recognize such workflow and reuse it for subsequent interactions. This form of local caching enhances efficiency by reducing latency and ensuring that user interactions proceed seamlessly without unnecessary reprocessing.

Referring back to FIG. 3, the context processor 308 thus generate the context 310 (e.g., whether the request relates to an existing session) for further processing by the model-transition system. Through intelligent context tracking and resource optimization, the model-transition system delivers a smoother and more responsive user experience.

### 3. Resource Matching

The model-transition system can select the appropriate machine-learning model and the methods of its deployment. In particular, the user request should be matched with an appropriate and available computing resource. For example, if a user makes a gesture to turn on the lights or issues a voice command, different models, processors, and algorithms can be used to interpret and execute these requests effectively. The challenge lies in ensuring that each request is mapped to the most suitable (as well as available) computing resource available at the moment the request is processed.

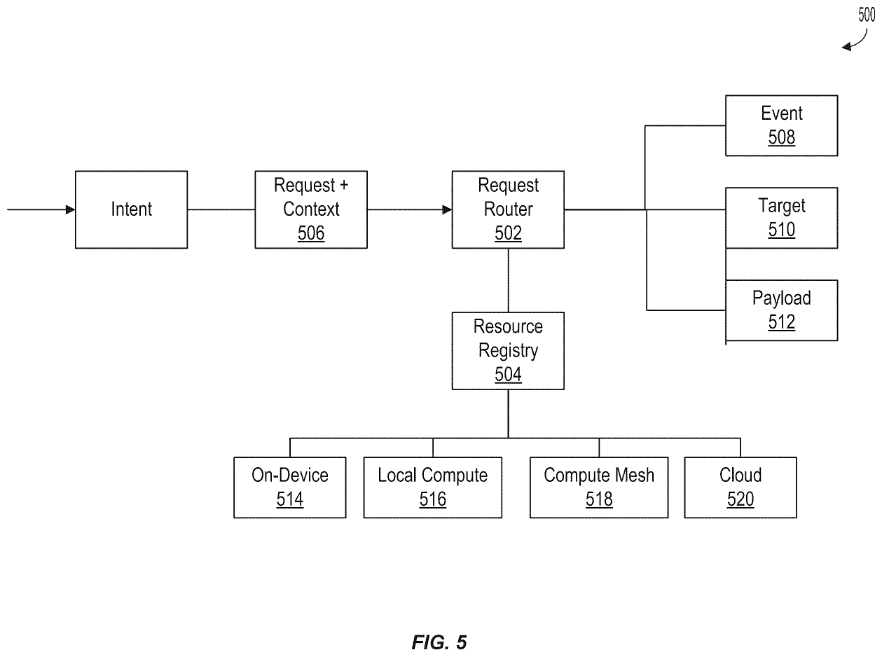

To address this issue, the model-transition system can include a request router 312 that accesses a resource registry to determine a processing route 314 that includes events, targets, and payload for handling the request and the context. Techniques for determining the processing route 314 is further described in FIG. 5 of the present disclosure. In some instances, the resource registry can identify all accessible computing resources for processing the user requests (e.g., the request 304). Whenever a new device or service is introduced—whether in a home, office, school, or other environment—the new device or service and its corresponding resources/capabilities can be registered and provisioned. Such configuration includes recording its available API endpoints, local storage capacity, and computing power. As an illustrative example, if a user installs a new gateway device, its processing capabilities can be provisioned such that applications can access its functions and services.

FIG. 5 illustrates a schematic diagram 500 for determining accessible resources and deployment options for processing machine-learning requests, according to some embodiments. As shown in FIG. 5, a request router 502 can access a resource registry 504 that maintains a real-time inventory of all available devices, services, and their capabilities that are associated with the user. The resource registry 504 can operate locally on the user's personal devices, in shared environments like office buildings, airplanes, hospitals, or stadiums, or even in the cloud. The resource registry 504 can be used to perform resource matching, ensuring that requests are routed to the most appropriate processing unit based on current availability and location. Additionally, the registry monitors the health and status of resources in real time, ensuring reliability and efficient load distribution.

Continuing with FIG. 5, once a request context 506 has been established—either from a new session or restored from a previous existing—the request router 502 can determine the optimal processing route to process the request. This routing decision can be made using different best-fit algorithms. In some instances, best-fit algorithms can be used to allocate resources efficiently across various domains. In memory allocation, the best-fit strategy assigns the smallest available memory block that can accommodate a process, reducing fragmentation. In bin packing problems, the algorithm places items in the tightest-fitting bin to minimize wasted space, with a variation called Best-Fit Decreasing (BFD) sorting items in decreasing order before applying the strategy. Scheduling applications use best-fit approaches to assign tasks to the most suitable time slot or processor, optimizing resource usage. In data analysis, best-fit curve fitting techniques, such as least squares regression, determine the mathematical function that best approximates a dataset. Similarly, in load balancing, best-fit algorithms distribute network traffic or computational tasks to the least loaded server that can handle the request efficiently.

The request router 502 can then generate the processing route based on the resource matching process. The processing route can include three components: (i) events 508; (ii) targets 510; and (iii) payloads 512. In some instances, the events 508 represent one or more actions required to fulfill the request, such as executing a task directly on an available device, downloading and deploying resources before execution, activating an on-demand resource, or offloading processing to a distributed computing system (e.g., compute mesh). The targets 510 are endpoints where the events 508 are directed, which may include on-device applications or services, computing devices, a gateway or home assistant devices, or remote cloud-based processing units. The payload 512 represents the data to be transmitted to the target 510. For example, the payload 512 can include input data required for processing. Additionally or alternatively, the payload 512 can include additional data to access the target, such as security credentials for access control, payment information for service usage, and privacy controls to enforce compliance with user preferences.

In some instances, the request router 502 can determine the processing route by processing the request context 506 (including the intent) using a route-determining machine-learning model. Examples of the route-determining machine-learning model can include algorithms such as k-means clustering algorithms, fuzzy c-means (FCM) algorithms, expectation-maximization (EM) algorithms, hierarchical clustering algorithms, and density-based spatial clustering of applications with noise (DBSCAN) algorithms, in which the algorithms can be trained using unsupervised learning. Other examples of the route-determining machine-learning model can include, but are not limited to, genetic algorithms, backpropagation, reinforcement learning, decision trees, linear classification, artificial neural networks, anomaly detection, and such. In yet other examples, the route-determining machine-learning model may include regression analysis, dimensionality reduction, metalearning, reinforcement learning, deep learning, and other such algorithms and/or methods.

In some instances, the machine-learning model is a transformer model (e.g., a large-language model (LLM)) obtained from a models database. In some instances, the machine-learning model is trained using self-supervised learning based on a large corpus of text data, such that the machine-learning model can generate processing route. In addition to training the model, various prompts can be used for prompt engineering of the machine-learning model for generating the processing route. Examples of the machine-learning model can include, but are not limited to, BERT model, Claude LLM, Falcon 40B, Ernie, GPT-3, GPT-3.5, GPT 4, Lamda, and Llama.

An illustrative example process of training and deploying the transformer model (e.g., a GPT model) is as follows. For the training dataset (e.g., the previous input data and processing route), the masked self-attention process can begin by transforming each word in a given training text sequence into three vectors: the query (Q), key (K), and value (V) vectors. A Q vector can represent what information the token is querying about other tokens, a K vector can represent the token's context used to establish relationships with other tokens, and a V vector can represent the token's actual content/information. In some instances, the Q, K, and V vectors can be obtained by multiplying the input embeddings by learned weight matrices.

An attention score for a particular word can be calculated by taking the dot product of the Q vector of the word with the K vectors of all words in the sequence, thereby producing a score that reflects the relevance of each word pair. The attention scores can be used as weights, which can be applied to the Q, K, V vectors to generate a weighted contextual representation of the particular word. Stated differently, the attention score can be used as a weight to transform the Q, K, V vectors of a given word to generate a weighted, computed representation that can be used to train the corresponding transformer model.

In some instances, a mask can be applied to the self-attention mechanism such that a contextual representation of a given token is determined without weights associated with future tokens. As a result, an attention score of a particular token can be adjusted to disregard information from tokens that have not been processed yet. The attention scores can then be scaled by the square root of the key dimension to stabilize training and passed through a softmax function to convert the attention scores into probabilities, ensuring they sum to one. The transformation can identify the most relevant words while downplaying less important ones. The resulting attention weights can then be used to compute a weighted sum of the V vectors, thus producing a new contextual representation for each token that incorporates contextual information from the entire sequence.

To enhance the model's ability to capture various types of relationships, self-attention mechanisms can use multiple sets of Q, K, and V matrices, also referred to as multi-head attention. Each set, or head, can learn different aspects of the relationships within the input data. The outputs from these heads can be concatenated and linearly transformed to form the final self-attention output. This multi-head approach allows the transformer models to simultaneously consider different features and interactions, enriching its understanding of the input sequence.

The transformer model can then be trained using autoregressive language modeling to predict a subsequent token of a target sequence based on the contextual representations that represent the preceding tokens. For each position in the sequence, the transformer model accesses a contextual representation of the token, which was generated using masked self-attention mechanism. The transformer model can then output a probability distribution over a vocabulary for the subsequent token, conditioned on the sequence of preceding tokens. The subsequent token can then be compared with a corresponding token of the training data to calculate a loss. The loss measures the discrepancy between the predicted token and the actual token, providing a signal for the model to adjust its parameters. The loss can then be used to adjust parameters of the transformer model, including the parameters of the Q, K, V matrices.

Through iterative training iterations, the transformer model learns to minimize this loss across the entire training dataset. This process ensures that the model generates coherent and contextually appropriate sequences by leveraging the learned representations and adjusting its parameters based on the training data.

In some instances, the request router 502 can construct one or more prompts that can be submitted with the request context 506 to enhance and increase the accuracy of the processing route. As used herein, the term “prompt” can refer to an input sequence generated to direct a corresponding machine-learning model's generation process towards producing a target output. In some instances, a filtering prompt includes a sequence of text tokens in a specific format (e.g., text, XML data, JSON data) and language (e.g., English, Korean).

In some instances, the prompts are machine-generated prompts that are generated by one or more computer systems without user intervention. For example, the one or more filtering prompts can be constructed using prompt engineering. Prompt engineering can include techniques for designing and implementing prompts within a machine-learning system to generate target responses or actions. In some instances, prompt engineering leverages a combination of linguistic approaches, machine-learning algorithms, and domain knowledge to formulate prompts that elicit specific outputs from a corresponding machine-learning model. The prompt engineering process typically begins with an analysis of a target or a problem domain, followed by the formulation of prompts tailored to achieve the desired results.

As an illustrative example for optimizing prompts, a prompt P can be defined as a sequence of tokens, tailored to elicit specific responses from a machine-learning model. The model employs an objective function O(P, R) to evaluate the quality of generated responses R given the prompt P. The responses R can be generated based on a machine-learning language model LM processing the prompt P (e.g., the function LM(P)). Different types of objective functions can be selected depending on the task and targeted output. For example, an objective function can correspond to a text summarization technique using ROUGE scores. In another example, the objective function can correspond to a translation quality assessment technique using BLEU scores. In some instances, optimization techniques like gradient descent or evolutionary algorithms are used iteratively refine the prompt P to maximize O(P, R), to facilitate the model to consistently produce accurate, relevant, and contextually appropriate outputs (e.g., the processing route). For example, the optimal prompt P* can be determine based on maximizing the objective function O:

$$P *= arg max O ( P , LM ( P ) ) \qquad Equation ( 1 )$$

Through the iterative refinement process, prompt engineering enhances the corresponding model's performance across various natural language processing tasks, such as generating the processing route that are contextually relevant to the request context 506.

In some instances, prompt engineering includes a selection of input formats and structures. The input-format selection can include determining the syntactic and semantic characteristics of the prompts that will effectively guide the machine-learning model towards the desired outputs. In some instances, linguistics and computational linguistics can be used to select input formats that are semantically meaningful and contextually relevant. The input-format selection can ensure that the prompts effectively communicate the desired tasks or questions to the machine-learning model. The prompt engineering process can also include an optimization of prompt parameters. The optimization can include fine-tuning various parameters such as prompt length, complexity, and specificity to enhance the machine-learning model's performance on targeted tasks. Different prompt formulations and configurations such as grid search or Bayesian optimization can be implemented to optimize the prompt parameters. Additionally or alternatively, techniques such as zero-shot learning or few-shot learning can be implemented to fine-tune the machine-learning models to generalize from limited prompt examples.

The prompt engineering process can be configured based on an underlying machine-learning model architecture and training data. For example, an appropriate pre-trained machine-learning model architecture (e.g., GPT, BERT, or Transformer) that aligns with the task requirements and available computational resources can be identified for a given task. In some instances, the machine-learning model can be fine-tuned on task-specific data to further improve probability of outputting target responses. Various types of training datasets can be used to train and fine-tune the machine-learning model, so as to enable the machine-learning model to understand and generate responses to prompts accurately.

In some instances, an iterative process of designing, testing, and optimizing prompts is implemented based on feedback from initial model outputs. This iterative approach allows for continuous improvement and refinement of the prompt engineering process, ultimately leading to better-performing machine-learning models. Additionally or alternatively, ongoing monitoring and evaluation of model performance can be used to identify any errors or biases introduced by the prompts and prompt engineering process, in which the feedback data can be generated based on the evaluation. The feedback data can be used to further adjust the parameters of the machine-learning models, such that the machine-learning models can be updated to improve accuracy in generating the target responses.

The request router 502 can apply the trained and fine-tuned machine-learning model to the request context 506 to generate the processing route. To begin the deployment process, the request router 502 can tokenize the merged data into a sequence of text tokens. For example, the merged data can be tokenized to provide the following sequence: [“You”, “are”, “an”, “assistant”, “tasked”, . . . ]. In some instances, the machine-learning model uses Byte Pair Encoding (BPE) techniques to further split a single token (e.g., “in”, “sufficient”).

The request router 502 can assign each token with a particular index value in the vocabulary (e.g., “assistant”=E[5]). Then, the request router 502 can convert each token into a vector representation (e.g., an embedding) based on a pre-trained embedding matrix. For example, for a vocabulary size V and embedding dimension dᵢ, the embedding matrix E is of size V×d, in which the vector eᵢ can be generated for the text token tᵢ based on using the index value looking at a corresponding row of embedding matrix E.

$$E : {e}_{i} = E [ {t}_{i} ] \qquad Equation ( 2 )$$

The request router 502 can then process the sequence of embeddings (e₁, e₂, e₃, . . . eₙ) that represent the sequence of tokens by adding positional encodings to account for the order of tokens. In some instances, positional encodings are vectors added to each token embedding to inject information about the position of tokens in the sequence. A matrix X can be formed that includes the sequence of position-encoded vectors.

For the matrix X, the request router 502 can then determine a contextual representation for each position-encoded vector of the matrix X. In particular, for each position-encoded vector, the request router 502 can generate a set of Q, K, V vectors for the position-encoded vector. As described herein, a Q vector can represent what information the token is querying about other tokens, a K vector can represent the token's context used to establish relationships with other tokens, and a V vector can represent the token's actual content/information.

In some instances, to enhance the model's ability to capture various types of relationships, the position-encoded vector can be represented by multiple sets of Q, K, and V matrices (i.e., multi-head attention). Each set of Q, K, V vectors, or head, can learn different aspects of the relationships within the input data. The outputs from these heads can be concatenated and linearly transformed to form the final self-attention output. This multi-head approach allows the transformer models to simultaneously consider different features and interactions, enriching its understanding of the input sequence.

An attention score can be calculated for the set of Q, K, V vectors as follows:

$$Attention ( Q , K , V ) = soft max ( ( {QK}^{T} ) / √ ( {d}_{k} ) ) V \qquad Equation ( 3 )$$

The (QK^{T})/√(dₖ) can be used to compute the raw attention scores, in which dₖ is the dimensionality of the key vectors. Then, the softmax function is applied to the raw attention score to normalize it into a probability distribution. The request router 502 can apply the attention score to a V vector of the corresponding set of Q, K, V vectors, such that the weighted Q, K, V vectors can be used as the contextual representation of the position-encoded vector of matrix X. In the instances in which multi-head attention is used, the multiple sets of weighted Q, K, V vectors can be concatenated and linearly transformed using a weight matrix W^{O} to generate the contextual representation of the position-encoded vector. The above process can be iterated through other position-encoded vectors of matrix X to generate a set of contextual representations associated with the merged data.

The request router 502 can then apply the machine-learning model to the set of contextual representations to generate the processing route. In particular, the machine-learning model can process the set of contextual representations to predict each token of the processing route, in which the output tokens can correspond to the processing route.

The above embodiments of request router 502 can be used for a broad range of processing scenarios. For example, operations may be performed directly on the user's own device 514. In another example, operations can be performed on a local gateway 516 such as an in-home assistant or an in-vehicle processor. In yet another example, the operations can be performed within a shared compute mesh 518 such as an office or stadium server, or remotely via cloud services 520 such as OpenAI, AWS, or Azure. Once the optimal processing route is determined, the request router 502 can transmit the request to the resources that can queue and process the request asynchronously using event-driven execution models or transactional processing systems. In some instances, the request router 502 can dynamically adapt as the user moves from one location to another, continuously seeking the best available processing route to handle requests in real time. This ensures seamless operation across different environments, maintaining system efficiency while optimizing the user experience.

### 4. Resource Management

Referring back to FIG. 3, the request router 312 can be configured continuously monitoring the health and availability of resources (as identified in the resource registry) during runtime. Various factors can impact resource availability, such as network congestion, temporary overload of compute services, or complete service downtime. To ensure that requests are directed to the most reliable and efficient resource at any given time, the router must actively assess the operational status of all available systems.

To achieve this, the request router 312 employs multiple health-checking mechanisms. One method involves monitoring heartbeats, where the absence of a periodic signal indicates that a resource has become unresponsive. In addition, the system performs scheduled health checks at regular intervals to assess resource functionality. Another approach involves subscribing to health status events broadcast by each computing resource, thereby allowing the request router 302 to receive real-time updates on their current state. Furthermore, the router can analyze the outcomes of recently processed requests, either directly or through third-party monitoring services, to detect performance issues or failures.

By continuously gathering and evaluating this health data, the request router 312 can make informed decisions about where to route incoming requests. This ensures that processing is dynamically adjusted based on the most up-to-date information and health status, allowing the system to maintain optimal performance and reliability even as network conditions and resource availability fluctuate.

In some embodiments, the request router 312 can also be configured to determine whether the user 306 is authorized to access the resources within the resource registry. The verification checks can include verifying authorization through access control lists, security tokens, or payment authentication systems (for example). Additionally or alternatively, the request router 312 can also assess system constraints and priority levels of the computing resources, to ensure that resource allocation aligns with operational policies associated with the resource providers.

If the user 306 does not have the necessary authorization to access a specific computing resource in the resource registry, the request router 312 may attempt to identify an alternative computing resource that can serve as a substitute for the computing resource identified in the processing route 314. The alternative selection can be performed on the user's current context, such as their location, device capabilities, or access privileges. By dynamically adjusting resource assignments, the request router 312 can ensure that user requests are handled efficiently while maintaining security and compliance with usage policies.

### 5. Response Handling

Continuing with FIG. 3, a request processor 316 can receive and process the request 304 using deployment configurations 318 specified by the optimal processing route 314 (e.g., on-premise, cloud). The request processor 316 can then generate an output generated by a corresponding machine-learning model. The machine-learning model can generate a variety of personalized tasks and outputs for an individual user based on their data, preferences, and behavior patterns. For example, in a health and wellness application, the model can analyze activity levels and generate customized fitness plans, recommend dietary adjustments, or provide alerts for irregular health metrics. In content recommendation systems, the model can curate personalized news articles, suggest movies or books, and refine search results based on past interactions. In language processing applications, it can generate text completions, assist with translations, or provide contextual grammar corrections. Additionally, in smart assistants, the model can automate scheduling, predict reminders, and optimize daily routines based on the user's habits.

In some instances, the request processor 316 can also generate a response 320 that includes one or more response states, each of which indicating the current status of processing the request 304. For example, a response 320 marked as “Success” signifies that the request has been fully processed and is complete. In cases where a response is streamed in multiple chunks, the request processor 316 tags the initial segment of the response 320 as “Start Sequence”. The initial segment can include additional metadata such as the expected number of responses, allowing for better user feedback. Subsequent parts of a streamed response 320 can be marked as “Continue Sequence”, signifying their connection to the initial segment associated with the ongoing request 314. Once the final segment has been sent, the request processor can designate the response 320 as “Sequence Done”, which can indicate either successful completion or a failure due to a timeout or processing error. If the request cannot be fulfilled, the response 320 is marked as “Failure”, signaling that the operation was unsuccessful.

In some instances, the request processor 316 can associate the response 320 with corresponding metadata that provides additional information associated with processing the request 304. This metadata can include the response status, time taken for execution, computational resources consumed, operational costs incurred, and the routing path followed. This metadata serves as feedback for the request router 312, enabling it to refine and fine-tune future routing decisions and improve overall system efficiency.

In particular, the request router 312 can receive feedback data (e.g., the metadata) from the user device, in which the feedback data is associated with the processing routes. The request router 312 thus allows for multiple iterations of providing feedback to an output, thus refining subsequent processing routes based on the feedback until a target output is achieved. The iterative approach facilitates increased efficiency in generating high-quality processing routes.

In some instances, the user interface of the user device can include one or more user-interface elements that facilitate review of the generated processing routes and provide immediate feedback. For example, the feedback data can include text inputted by the users. In some instances, a free text box is provided for detailed feedback. In another example, the feedback can include interacting with a graphical user-interface element that indicates approval or disapproval of the generated content (e.g., clicking a thumbs up/down icon).

In some instances, the feedback data includes one or more modifications to the processing routes. In some instances, the feedback data further includes an approval or disapproval of the processing routes. In some instances, the request router 312 provides a content editor to support the one or more modifications. After receiving the feedback data from the user device, the request router 312 can adjust one or more parameters of the machine-learning model based on a loss determined between the one or more modifications and corresponding portions of the processing routes. The loss can be determined using different loss functions, such as regression, classification, or other specialized tasks. For example, Variational Autoencoder (VAE) loss can be used, in which the VAE loss can be determined using a combination of reconstruction loss and Kullback-Leibler (KL) divergence. The reconstruction loss, typically measured as the Mean Squared Error (MSE) or Binary Cross-Entropy (BCE), can quantify how well the generated data (e.g., data-collection script 218) matches the modified data-collection script, encouraging accurate data reconstruction. The KL divergence term measures how closely the learned latent variable distribution approximates the prior distribution, usually a standard normal distribution.

In some instances, the request router 312 adjusts the one or more parameters of the machine-learning model using reinforcement learning. Reinforcement Learning (RL) is a machine learning paradigm where an automated agent learns to make decisions by interacting with the request router 312 to maximize cumulative rewards. The fundamental components of RL include the automated agent, environment, state, action, reward, policy, value function, and Q-value. The automated agent can interact with the request router 312 in a loop, taking actions based on the current policy, observing the resulting state and reward, and updating its policy and value function accordingly.

Examples of RL algorithms include Q-learning, SARSA, Deep Q-Networks (DQN), policy gradient methods, and actor-critic methods. For example, Q-learning can be an off-policy approach, in which the Q-value function is updated using the maximum estimated future rewards. In another example, SARSA is an on-policy method that updates the Q-value function based on the action actually taken by the current policy. DQN can use another neural network to approximate the Q-value function and uses various techniques (e.g., experience replay) to stabilize training. The loss function in DQN is the Mean Squared Error (MSE) between predicted and target Q-values, which is minimized using gradient descent.

As a result, the feedback data can be used for further training and fine-tuning of the machine-learning model to generate future processing routes that accurately correlates the input data with the processing routes, including accounting for the contextual data inputted by the users.

### C. Methods

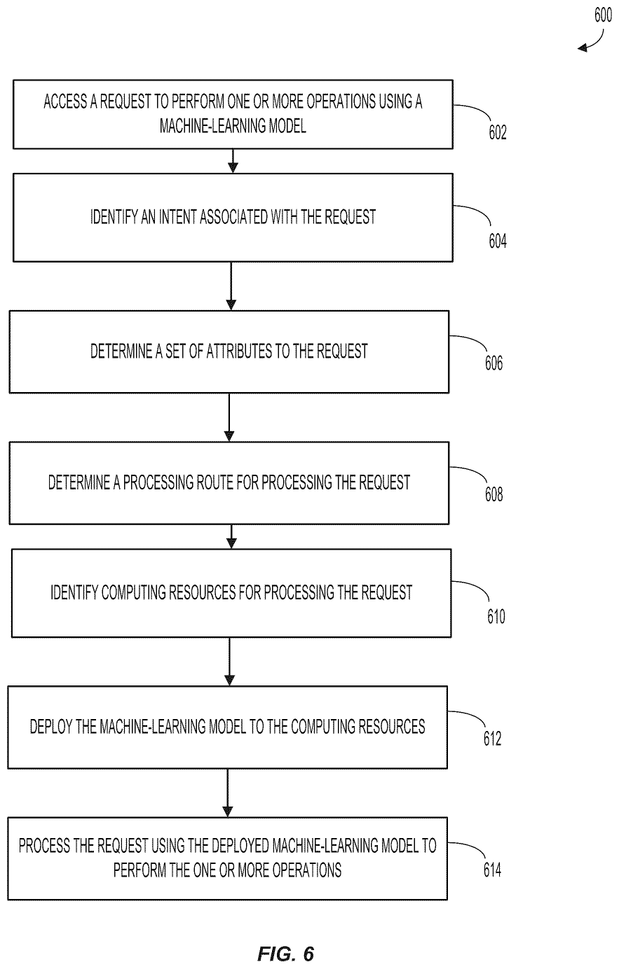

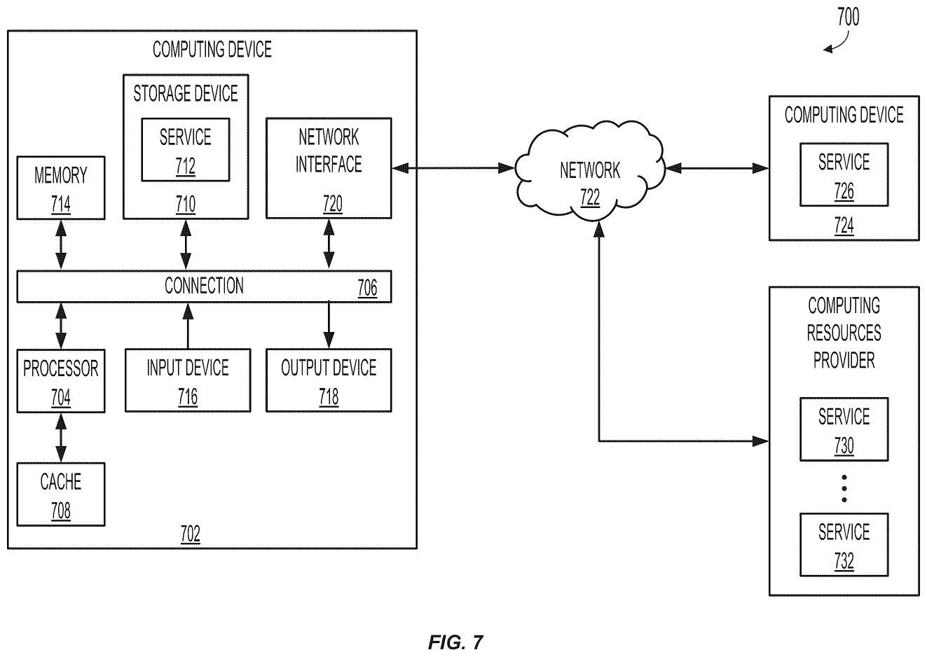

FIG. 6 shows an illustrative example of a process 600 for selecting and transitioning machine-learning deployments based on device and network characteristics, in accordance with some embodiments. For illustrative purposes, the process 600 is described with reference to the components illustrated in FIGS. 2-6, though other implementations are possible. For example, the program code for the model-transition system of FIG. 3, is executed by one or more processing devices to cause a server system (e.g., the computing device 702 of FIG. 7) to perform one or more operations described herein.

At step 602, the model transition system accesses a request to perform one or more operations using a machine-learning model, in which the request is associated with a user.

At step 604, the model transition system identifies an intent associated with the request. In some instances, the intent identifies one or more intended inputs for the machine-learning model and an expected output to be generated by the machine-learning model in response to the one or more intended inputs.

At step 606, the model transition system determines a set of attributes to the request based on the intent. The set of attributes identifies one or more device or network characteristics associated with processing the intent. For example, the set of attributes can include network bandwidth for processing the request, time elapsed from a previous request, availability of computing resources, and proximity to alternative computing resources.

In some instances, the set of attributes indicate whether the request is associated with an existing communication session associated with the machine-learning model. For example, the model transition system can generate a query using the intent and the set of attributes and submit the query to the request database to retrieve query results that correspond to sessions. If the request is determined to the associated with an existing session, the model transition system can reuse the established settings and routing paths of an existing session. Additionally or alternatively, the model transition system can compare operational attributes of the existing session with the set of attributes of the request to determine any changing conditions, such as shifts in resource availability or the user moving to a different location. If the difference between the sets of attributes exceeds a threshold, the model transition system can adjust the deployment options and resource usage that would match the operational attributes of the request.

At step 608, the model transition system determines a processing route for processing the request. In some instances, the processing route is determined based on the request, the intent, and the set of attributes. The processing route can include: (i) an event that identifies one or more actions to fulfill the request; (ii) a target that identifies resource endpoints to which the event is being directed; and (iii) a payload that includes metadata associated with the request.

In some instances, the model transition system determines the processing route by accessing a resource registry. In some instances, the resource registry can identify all accessible computing resources for processing the user requests. Whenever a new device or service is introduced—whether in a home, office, school, or other environment—the new device or service and its corresponding resources/capabilities can be registered and provisioned. Such configuration includes recording its available API endpoints, local storage capacity, and computing power.

In some instances, the model transition system determines the processing route by applying a route-determining machine-learning model to the request, the intent, and the set of attributes. Examples of the route-determining machine-learning model can include algorithms such as k-means clustering algorithms, fuzzy c-means (FCM) algorithms, expectation-maximization (EM) algorithms, hierarchical clustering algorithms, and density-based spatial clustering of applications with noise (DBSCAN) algorithms, in which the algorithms can be trained using unsupervised learning. Other examples of the route-determining machine-learning model can include, but are not limited to, genetic algorithms, backpropagation, reinforcement learning, decision trees, linear classification, artificial neural networks, anomaly detection, and such. In yet other examples, the route-determining machine-learning model may include regression analysis, dimensionality reduction, metalearning, reinforcement learning, deep learning, and other such algorithms and/or methods.

In some instances, the machine-learning model is a transformer model (e.g., a large-language model (LLM)) obtained from a models database. In some instances, the machine-learning model is trained using self-supervised learning based on a large corpus of text data, such that the machine-learning model can generate processing route. In addition to training the model, various prompts can be used for prompt engineering of the machine-learning model for generating the processing route. Examples of the machine-learning model can include, but are not limited to, BERT model, Claude LLM, Falcon 40B, Ernie, GPT-3, GPT-3.5, GPT 4, Lamda, and Llama.

At step 610, the model transition system identifies computing resources for processing the request, in which the computing resources are identified based on the processing route. In some instances, the computing resources are associated with a local computing device or a remote computing environment. Examples of the computing resources can include but are not limited to CPU, RAM, GPU, NPU, and TPU.

At step 612, the model transition system deploys the machine-learning model to the computing resources. For example, the machine-learning model can be deployed on the user's own device. In another example, the machine-learning model can be deployed on a local gateway such as an in-home assistant or an in-vehicle processor. In yet another example, the machine-learning model can be deployed on a shared compute mesh such as an office or stadium server, or remotely via cloud services such as OpenAI, AWS, or Azure. Accordingly, the model transition system queue and process the request asynchronously using event-driven execution models or transactional processing systems.

At step 614, the model transition system processes the request using the deployed machine-learning model to perform the one or more operations. The machine-learning model can generate a variety of personalized tasks and outputs for an individual user based on their data, preferences, and behavior patterns. For example, in a health and wellness application, the model can analyze activity levels and generate customized fitness plans, recommend dietary adjustments, or provide alerts for irregular health metrics. In content recommendation systems, the model can curate personalized news articles, suggest movies or books, and refine search results based on past interactions. In language processing applications, it can generate text completions, assist with translations, or provide contextual grammar corrections. Additionally, in smart assistants, the model can automate scheduling, predict reminders, and optimize daily routines based on the user's habits.

In some instances, the model transition system generates a response message that identifies a status associated with processing the request. For example, a response marked as “Success” signifies that the request has been fully processed and is complete. In cases where a response is streamed in multiple chunks, the model transition system tags the initial segment of the response as “Start Sequence”. The initial segment can include additional metadata such as the expected number of responses, allowing for better user feedback. Subsequent parts of a streamed response can be marked as “Continue Sequence”, signifying their connection to the initial segment associated with the ongoing request 314. Once the final segment has been sent, the model transition system can designate the response as “Sequence Done”, which can indicate either successful completion or a failure due to a timeout or processing error. If the request cannot be fulfilled, the response is marked as “Failure”, signaling that the operation was unsuccessful.

In some instances, the model transition system may re-deploy the machine-learning model if the user has moved to a different location. For example, the request is associated with a first location. If it is detected that the user has relocated to a second location while the machine-learning model is processing the request, the model transition system iterates steps of identifying another intent, determining another set of attributes, and determining another processing route to identify alternative computing resources for processing the request. The model transition system can then re-deploy the machine-learning model to the alternative computing resources. Process 600 terminates thereafter.

### II. Example Systems

FIG. 7 illustrates a computing system architecture 700, including various components in electrical communication with each other, in accordance with some embodiments. The example computing system architecture 700 illustrated in FIG. 7 includes a computing device 702, which has various components in electrical communication with each other using a connection 706, such as a bus, in accordance with some implementations. The example computing system architecture 700 includes a processing unit 704 that is in electrical communication with various system components, using the connection 706, and including the system memory 714. In some embodiments, the system memory 714 includes read-only memory (ROM), random-access memory (RAM), and other such memory technologies including, but not limited to, those described herein. In some embodiments, the example computing system architecture 700 includes a cache 708 of high-speed memory connected directly with, in close proximity to, or integrated as part of the processor 704. The system architecture 700 can copy data from the memory 714 and/or the storage device 710 to the cache 708 for quick access by the processor 704. In this way, the cache 708 can provide a performance boost that decreases or eliminates processor delays in the processor 704 due to waiting for data. Using modules, methods and services such as those described herein, the processor 704 can be configured to perform various actions. In some embodiments, the cache 708 may include multiple types of cache including, for example, level one (L1) and level two (L2) cache. The memory 714 may be referred to herein as system memory or computer system memory. The memory 714 may include, at various times, elements of an operating system, one or more applications, data associated with the operating system or the one or more applications, or other such data associated with the computing device 702.

Other system memory 714 can be available for use as well. The memory 714 can include multiple different types of memory with different performance characteristics. The processor 704 can include any general purpose processor and one or more hardware or software services, such as service 712 stored in storage device 710, configured to control the processor 704 as well as a special-purpose processor where software instructions are incorporated into the actual processor design. The processor 704 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 704 can be a microprocessor, a microcontroller, a digital signal processor (“DSP”), or a combination of these and/or other types of processors. In some embodiments, the processor 704 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

In some embodiments, the processor 804 can include multiple elements such as a core, one or more registers, and one or more processing units such as arithmetic logic units (ALU), floating point units (FPU), graphics processing units (GPU), physics processing units (PPU), neural processing units (NPU), tensor processing units (TPU), digital system processing (DSP) units, or combinations of these and/or other such processing units. The processor 804 can be implemented through different processor architectures, such as Reduced Instruction Set Computing (RISC) architectures (e.g., RISC-V, etc.), Advanced RISC Machine (ARM) architectures, and the like.

To enable user interaction with the computing system architecture 700, an input device 716 can represent any number of input mechanisms, such as a microphone for speech, a touch-sensitive screen for gesture or graphical input, keyboard, mouse, motion input, pen, and other such input devices. An output device 718 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 700. In some embodiments, the input device 716 and/or the output device 718 can be coupled to the computing device 702 using a remote connection device such as, for example, a communication interface such as the network interface 720 described herein. In such embodiments, the communication interface can govern and manage the input and output received from the attached input device 716 and/or output device 718. As may be contemplated, there is no restriction on operating on any particular hardware arrangement and accordingly the basic features here may easily be substituted for other hardware, software, or firmware arrangements as they are developed.

In some embodiments, the storage device 710 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 710 can include hardware and/or software services such as service 712 that can control or configure the processor 704 to perform one or more functions including, but not limited to, the methods, processes, functions, systems, and services described herein in various embodiments. In some embodiments, the hardware or software services can be implemented as modules. As illustrated in example computing system architecture 700, the storage device 710 can be connected to other parts of the computing device 702 using the system connection 706. In some embodiments, a hardware service or hardware module such as service 712, that performs a function can include a software component stored in a non-transitory computer-readable medium that, in connection with the necessary hardware components, such as the processor 704, connection 706, cache 708, storage device 710, memory 714, input device 716, output device 718, and so forth, can carry out the functions such as those described herein.

The disclosed systems and service of a model-transition system (e.g., the model-transition system described herein at least in connection with FIG. 3) can be performed using a computing system such as the example computing system illustrated in FIG. 7, using one or more components of the example computing system architecture 700. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and systems for associated with the model-transition system described herein at least in connection with FIG. 3 described herein by, for example, executing code using a processor such as processor 704 wherein the code is stored in memory such as memory 714 as described herein. One or more of a user device, a provider server or system, a database system, or other such devices, services, or systems may include some or all of the components of the computing system such as the example computing system illustrated in FIG. 7, using one or more components of the example computing system architecture 700 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 728. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 704 can be a conventional microprocessor such as an Intel® microprocessor, an AMD® microprocessor, a Motorola® microprocessor, ARM, RISC-V, or other such microprocessors. One of skill in the relevant art will recognize that the terms “machine-readable (storage) medium” or “computer-readable (storage) medium” include any type of device that is accessible by the processor.

The memory 714 can be coupled to the processor 704 by, for example, a connector such as connector 706, or a bus. As used herein, a connector or bus such as connector 706 is a communications system that transfers data between components within the computing device 702 and may, in some embodiments, be used to transfer data between computing devices. The connector 706 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 714 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 714 can also include magnetic or optical data storage media including read-only (e.g., CD ROM and DVD ROM) or otherwise (e.g., CD or DVD). The memory can be local, remote, or distributed.

As described above, the connector 706 (or bus) can also couple the processor 704 to the storage device 710, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 710. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 706 can also couple the processor 704 to a network interface device such as the network interface 720. The interface can include one or more of a modem or other such network interfaces including, but not limited to those described herein. It will be appreciated that the network interface 720 may be considered to be part of the computing device 702 or may be separate from the computing device 702. The network interface 720 can include one or more of an analog modem, Integrated Services Digital Network (ISDN) modem, cable modem, token ring interface, satellite transmission interface, or other interfaces for coupling a computer system to other computer systems. In some embodiments, the network interface 720 can include one or more input and/or output (I/O) devices. The I/O devices can include, by way of example but not limitation, input devices such as input device 716 and/or output devices such as output device 718. For example, the network interface 720 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, Android/AOSP, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, embedded systems such as FreeRTOS, Zephyr, and Arduino, real-time operating systems, languages, and devices, listed herein may be registered trademarks, service marks, or designs of various associated entities.

In some embodiments, the computing device 702 can be connected to one or more additional computing devices such as computing device 724 via a network 722 using a connection such as the network interface 720. In such embodiments, the computing device 724 may execute one or more services 726 to perform one or more functions under the control of, or on behalf of, programs and/or services operating on computing device 702. In some embodiments, a computing device such as computing device 724 may include one or more of the types of components as described in connection with computing device 702 including, but not limited to, a processor such as processor 704, a connection such as connection 706, a cache such as cache 708, a storage device such as storage device 710, memory such as memory 714, an input device such as input device 716, and an output device such as output device 718. In such embodiments, the computing device 724 can carry out the functions such as those described herein in connection with computing device 702. In some embodiments, the computing device 702 can be connected to a plurality of computing devices such as computing device 724, each of which may also be connected to a plurality of computing devices such as computing device 724. Such an embodiment may be referred to herein as a distributed computing environment.

The network 722 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 722 can be wired connections, wireless connections, or combinations thereof. Communications via the network 722 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), RPC, Matter, CANBus, and other such communications protocols.

Communications over the network 722, within the computing device 702, within the computing device 724, or within the computing resources provider 728 can include information, which also may be referred to herein as content. The information may include text, graphics, audio, video, haptics, and/or any other information that can be provided to a user of the computing device such as the computing device 702. In some embodiments, the information can be delivered using a transfer protocol such as Hypertext Markup Language (HTML), Extensible Markup Language (XML), JavaScript®, Cascading Style Sheets (CSS), JavaScript® Object Notation (JSON), Protobuf, MsgPack, BSON, and other such protocols and/or structured languages. The information may first be processed by the computing device 702 and presented to a user of the computing device 702 using forms that are perceptible via sight, sound, smell, taste, touch, or other such mechanisms. In some embodiments, communications over the network 722 can be received and/or processed by a computing device configured as a server. Such communications can be sent and received using PHP: Hypertext Preprocessor (“PHP”), Python™, Ruby, Perl® and variants, Java®, HTML, XML, C, C++, Lua, Swift, Kotlin, or another such server-side processing language.

In some embodiments, the computing device 702 and/or the computing device 724 can be connected to a computing resources provider 728 via the network 722 using a network interface such as those described herein (e.g. network interface 720). In such embodiments, one or more systems (e.g., service 730 and service 732) hosted within the computing resources provider 728 (also referred to herein as within “a computing resources provider environment”) may execute one or more services to perform one or more functions under the control of, or on behalf of, programs and/or services operating on computing device 702 and/or computing device 724. Systems such as service 730 and service 732 may include one or more computing devices such as those described herein to execute computer code to perform the one or more functions under the control of, or on behalf of, programs and/or services operating on computing device 702 and/or computing device 724.

For example, the computing resources provider 728 may provide a service, operating on service 730 to store data for the computing device 702 when, for example, the amount of data that the computing device 702 exceeds the capacity of storage device 710. In another example, the computing resources provider 728 may provide a service to first instantiate a virtual machine (VM) on service 732, use that VM to access the data stored on service 732, perform one or more operations on that data, and provide a result of those one or more operations to the computing device 702. Such operations (e.g., data storage and VM instantiation) may be referred to herein as operating “in the cloud,” “within a cloud computing environment,” or “within a hosted virtual machine environment,” and the computing resources provider 728 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 728 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, server-less hosting, virtual reality (VR) systems, and augmented reality (AR) systems. Various techniques to facilitate such services include, but are not be limited to, virtual machines, virtual storage, database services, system schedulers (e.g., hypervisors), resource management systems, various types of short-term, mid-term, long-term, and archival storage devices, etc.

As may be contemplated, the systems such as service 730 and service 732 may implement versions of various services (e.g., the service 712 or the service 726) on behalf of, or under the control of, computing device 702 and/or computing device 724. Such implemented versions of various services may involve one or more virtualization techniques so that, for example, it may appear to a user of computing device 702 that the service 712 is executing on the computing device 702 when the service is executing on, for example, service 730. As may also be contemplated, the various services operating within the computing resources provider 728 environment may be distributed among various systems within the environment as well as partially distributed onto computing device 724 and/or computing device 702.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 702) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purpose computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the example process 600 of FIG. 6). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, linear classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistants (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 702.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 45 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that the same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method comprising:
accessing a request to perform one or more operations using a machine-learning model, wherein the request is associated with a user;
identifying an intent associated with the request, wherein the intent identifies one or more intended inputs for the machine-learning model and an expected output to be generated by the machine-learning model in response to the one or more intended inputs;
determining a set of attributes to the request, wherein the set of attributes are determined based on the intent, and wherein the set of attributes identify one or more device or network characteristics associated with processing the intent;
determining a processing route for processing the request, wherein the processing route is determined based on the request, the intent, and the set of attributes, and wherein the processing route includes an event that identifies one or more actions to fulfill the request, a target that identifies resource endpoints to which the event is being directed, and a payload that includes metadata associated with the request;
deploying the machine-learning model according to the processing route ; and
processing the request using the deployed machine-learning model to perform the one or more operations.

2. The computer-implemented method of claim 1, wherein determining the processing route includes accessing a resource registry.

3. The computer-implemented method of claim 1, wherein determining the processing route includes applying a route-determining machine-learning model to the request, the intent, and the set of attributes.

4. The computer-implemented method of claim 1, wherein the set of attributes includes network bandwidth for processing the request, time elapsed from a previous request, availability of computing resources, and proximity to alternative computing resources.

5. The computer-implemented method of claim 1, wherein the computing resources are associated with a local computing device or a remote computing environment.

6. The computer-implemented method of claim 1, wherein processing the request using the deployed machine-learning model includes generating a response message that identifies a status associated with processing the request.

7. The computer-implemented method of claim 1, wherein the request is associated with a first location, the method further comprising:
detecting that the user has relocated to a second location while the machine-learning model is processing the request, wherein the second location is different from the first location;
iterating steps of identifying another intent, determining another set of attributes, and determining another processing route to identify alternative computing resources for processing the request; and
re-deploying the machine-learning model to the alternative computing resources.

8. The computer-implemented method of claim 1, wherein the set of attributes indicate whether the request is associated with an existing communication session associated with the machine-learning model.

9. A system comprising:
one or more processors; and
memory storing thereon instructions that, as a result of being executed by the one or more processors, cause the system to perform operations comprising:
accessing a request to perform one or more operations using a machine-learning model, wherein the request is associated with a user;
identifying an intent associated with the request, wherein the intent identifies one or more intended inputs for the machine-learning model and an expected output to be generated by the machine-learning model in response to the one or more intended inputs;
determining a set of attributes to the request, wherein the set of attributes are determined based on the intent, and wherein the set of attributes identify one or more device or network characteristics associated with processing the intent;
determining a processing route for processing the request, wherein the processing route is determined based on the request, the intent, and the set of attributes, and wherein the processing route includes: (i) an event that identifies one or more actions to fulfill the request; (ii) a target that identifies resource endpoints to which the event is being directed; and (iii) a payload that includes metadata associated with the request;
identifying computing resources for processing the request, wherein the computing resources are identified based on the processing route;
deploying the machine-learning model to the computing resources; and
processing the request using the deployed machine-learning model to perform the one or more operations.

10. The system of claim 9, wherein determining the processing route includes accessing a resource registry.

11. The system of claim 9, wherein determining the processing route includes applying a route-determining machine-learning model to the request, the intent, and the set of attributes.

12. The system of claim 9, wherein the set of attributes includes network bandwidth for processing the request, time elapsed from a previous request, availability of computing resources, and proximity to alternative computing resources.

13. The system of claim 9, wherein the computing resources are associated with a local computing device or a remote computing environment.

14. The system of claim 9, wherein processing the request using the deployed machine-learning model includes generating a response message that identifies a status associated with processing the request.

15. The system of claim 9, wherein the request is associated with a first location, and wherein the instructions further cause the system to perform operations comprising:
detecting that the user has relocated to a second location while the machine-learning model is processing the request, wherein the second location is different from the first location;
iterating steps of identifying another intent, determining another set of attributes, and determining another processing route to identify alternative computing resources for processing the request; and
re-deploying the machine-learning model to the alternative computing resources.

16. The system of claim 9, wherein the set of attributes indicate whether the request is associated with an existing communication session associated with the machine-learning model.

17. A non-transitory, computer-readable storage medium storing thereon executable instructions that, as a result of being executed by one or more processors of a computer system, cause the computer system to perform operations comprising:
accessing a request to perform one or more operations using a machine-learning model, wherein the request is associated with a user;
identifying an intent associated with the request, wherein the intent identifies one or more intended inputs for the machine-learning model and an expected output to be generated by the machine-learning model in response to the one or more intended inputs;
determining a set of attributes to the request, wherein the set of attributes are determined based on the intent, and wherein the set of attributes identify one or more device or network characteristics associated with processing the intent;
determining a processing route for processing the request, wherein the processing route is determined based on the request, the intent, and the set of attributes, and wherein the processing route includes: (i) an event that identifies one or more actions to fulfill the request;
(ii) a target that identifies resource endpoints to which the event is being directed; and (iii) a payload that includes metadata associated with the request;
identifying computing resources for processing the request, wherein the computing resources are identified based on the processing route;
deploying the machine-learning model to the computing resources; and
processing the request using the deployed machine-learning model to perform the one or more operations.

18. The non-transitory, computer-readable storage medium of claim 17, wherein determining the processing route includes accessing a resource registry.

19. The non-transitory, computer-readable storage medium of claim 17, wherein determining the processing route includes applying a route-determining machine-learning model to the request, the intent, and the set of attributes.

20. The non-transitory, computer-readable storage medium of claim 17, wherein the set of attributes includes network bandwidth for processing the request, time elapsed from a previous request, availability of computing resources, and proximity to alternative computing resources.

21. The non-transitory, computer-readable storage medium of claim 17, wherein the computing resources are associated with a local computing device or a remote computing environment.

22. The non-transitory, computer-readable storage medium of claim 17, wherein processing the request using the deployed machine-learning model includes generating a response message that identifies a status associated with processing the request.

23. The non-transitory, computer-readable storage medium of claim 17, wherein the request is associated with a first location,, and wherein the instructions further cause the computer system to perform operations comprising:
detecting that the user has relocated to a second location while the machine-learning model is processing the request, wherein the second location is different from the first location;
iterating steps of identifying another intent, determining another set of attributes, and determining another processing route to identify alternative computing resources for processing the request; and
re-deploying the machine-learning model to the alternative computing resources.

24. The non-transitory, computer-readable storage medium of claim 17, wherein the set of attributes indicate whether the request is associated with an existing communication session associated with the machine-learning model.
